(19) United States
(12) Patent Application Publication
(10) Pub. No.: US 2015/0348131 A1
(43) Pub. Date: Dec. 3, 2015

(54) METHOD, SYSTEM AND RECORDING MEDIUM FOR PROVIDING IMAGE USING METADATA OF IMAGE FILE

(71) Applicant: NAVER Corporation, Seongnam-si (KR)

(72) Inventor: Yung Seong Lee, Seongnam-si (KR)

(21) Appl. No.: 14/724,139

(22) Filed: May 28, 2015

(30) Foreign Application Priority Data
May 28, 2014 (KR) 10-2014-0064294

(51) Int. Cl. G06Q 30/02; G06Q 30/06; G06F 17/30; G06K 9/62

(52) U.S. Cl. CPC G06Q 30/0274; G06K 9/6267; G06Q 30/0643; G06F 17/30268; G06K 9/6201; G06Q 30/0631

(57) ABSTRACT

A method, system, and recording medium for providing an image using metadata of an image file are provided. An image providing method includes matching a meta tag for search with an image by analyzing metadata of the image in response to a first user uploading the image; and classifying and displaying the image based on the meta tag in response to an image read request of a second user.

### CROSS-REFERENCE TO RELATED APPLICATION

This application claims priority from and the benefit of Korean Patent Application No. 10-2014-0064294, filed on May 28, 2014, which is hereby incorporated by reference for all purposes as if fully set forth herein.

### BACKGROUND

1. Field

Example embodiments of the present invention relate to an image providing method and system for providing an image based service.

2. Description of the Background

Recently, a variety of image based services have emerged, and the need for searching for content associated with an image found on the Internet has been on the increase.

As an example of image search technology, Korean Patent Laid-Open Publication No. 10-2010-0050110, published on May 13, 2010, titled “method, terminal, image search server, and system for providing an image search service” discloses a technology for providing an image search function based on an image.

An image based service according to the related art may sort and thereby display image files based on a predetermined criterion and have some constraints in providing an expanded service. That is, the conventional service simply uses an image already present on the Internet and thus, does not appropriately use significant data contained in the source image. Accordingly, results away from the user intent may be unilaterally provided.

### SUMMARY

Example embodiments of the present invention provide an image providing method and system that create an image database including a space axis and a time axis by automatically analyzing metadata of a backup image and provide an image from the image database.

Example embodiments also provide an image providing method and system that search for an image based on a region of interest (ROI) of a user.

Example embodiments also provide an image providing method and system that search for an image of a predetermined place based on a season, a time, and weather.

Example embodiments also provide an image providing method and system that relay a related image in association with a travel product based on metadata of an image.

Example embodiments also provide an image providing method and system that recommend a travel product associated with an image based on metadata of the image.

Example embodiments also provide an image providing method and system that share revenues earned through a marketing channel using an image with an image creator.

According to an aspect of the present invention, there is provided an image providing method executed by a computer, the method including matching a meta tag for search with an image by analyzing metadata of the image in response to a first user uploading the image, and classifying and displaying the image based on the meta tag in response to an image read request of a second user.

According to another aspect, there is provided an image providing system including an image tagger configured to match a meta tag for search with an image by analyzing metadata of the image in response to a first user uploading the image, and an image provider configured to classify and display the image based on the meta tag in response to an image read request of a second user.

According to still another aspect, there is provided a non-transitory computer-readable medium storing instructions to control a computer system to provide a map service, wherein the instructions control the computer system by a method including matching a meta tag for search with an image by analyzing metadata of the image in response to a first user uploading the image, linking at least one travel product with the image using the meta tag, classifying and displaying the image based on the meta tag in response to an image read request of a second user, and displaying a travel product linked with a predetermined image in response to the image selected by the second user from among the displayed images.

It is to be understood that both the foregoing general description and the following detailed description are explanatory and are intended to provide further explanation of the present invention as claimed.

### EFFECT OF EXAMPLE EMBODIMENTS

According to example embodiments of the present invention, it is possible to create a matching database in which an image is classifiable based on at least one of space, time, and weather by analyzing metadata of the image. Accordingly, it is possible to provide an expanded service by efficiently using significant data of a source image.

Also, according to example embodiments, it is possible to conduct an image search based on a region of interest (ROI) of a user. Further, it is possible to search for an image of a predetermined place based on season, time, and weather.

Also, according to example embodiments, it is possible to effectively recommend a travel product associated with an image through matching between the travel product and the image by linking the travel product with the image based on metadata of the image.

Also, according to example embodiments, it is possible to achieve revenues by using an image as a marketing channel. Here, it is possible to further efficiently advertise a product by sharing the revenues with an image creator.

### BRIEF DESCRIPTION OF THE DRAWINGS

The accompanying drawings, which are included to provide a further understanding of the example embodiments of the present invention and are incorporated in and constitute a part of this specification, illustrate example embodiments, and together with the description serve to explain the principles of the example embodiments.

FIG. 1 is a diagram illustrating of an image based service environment according to one example embodiment.

FIG. 2 is a block diagram illustrating a configuration of an image providing system according to an example embodiment.

FIG. 3 is a flowchart illustrating an image providing method according to one example embodiment.

FIG. 4 is a flowchart illustrating a process of creating an image database by analyzing metadata of an image according to an example embodiment.

FIG. 5 illustrates an image database having a space axis and a time axis according to an example embodiment.

FIG. 6 illustrates matching between an image and a travel product according to an example embodiment.

FIG. 7 is a flowchart illustrating a process of visualizing an image according to one example embodiment.

FIG. 8 illustrates an example of visualizing an image corresponding to a time and a place requested by a user.

FIG. 9 illustrates an example of visualizing details information of an image selected by a user.

FIG. 10 is a flowchart illustrating a process of recommending a travel product according to an example embodiment.

FIG. 11 illustrates an example of visualizing a travel product linked with an image selected by a user.

FIG. 12 illustrates an example of a configuration of a computer system according to one example embodiment.

### DETAILED DESCRIPTION OF EXAMPLE EMBODIMENTS

The invention is described more fully hereinafter with reference to the accompanying drawings, in which example embodiments are shown. This invention may, however, be embodied in many different forms and should not be construed as limited to the example embodiments set forth herein. Rather, these example embodiments are provided so that this disclosure is thorough, and will fully convey the scope of the invention to those skilled in the art.

In the drawings, the size and relative sizes of layers and areas may be exaggerated for clarity. Like reference numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, areas, layers and/or sections, these elements, components, areas, layers and/or sections should not be limited by these terms. These terms are only used to distinguish one element, component, area, layer or section from another element, component, area, layer or section. Thus, a first element, component, area, layer or section discussed below could be termed a second element, component, area, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, example embodiments of the present invention will be described with reference to the accompanying drawings.

The example embodiments relate to providing an image based service, and more particularly, to providing a service suitable for a user intent and a consumption reaction based on an Internet use behavioral pattern, for example, Attention, Interest, Search, Action, Share (AISAS). For example, the example embodiments relate to providing contents capable of drawing a user's interest when the user is surfing the Internet for pictures, for example, information regarding “where is it?”, “how can we go there?”, “which season?”, “how long will it take to get there”, and “how much would it be to get there?”.

The term “image” used herein may inclusively indicate any type of images that can be visualized through media, such as a photo and a video.

Further, the term “image” may indicate any material provided in an image form among contents present on the Internet. In general, content (hereinafter, an image) configured in an image form may be as follow:
a photo of a person, for example, a celebrity, a sports player, and a politician
a poster and a pamphlet associated with a movie, a drama, and a performance, and other promotion materials
contents associated with a cartoon, a game, a movie, and a drama
a landscape photo, an animal, a plant, a vehicle, and a work of art
a wallpaper of a PC or a mobile device
a clip art and an icon
other images or photos

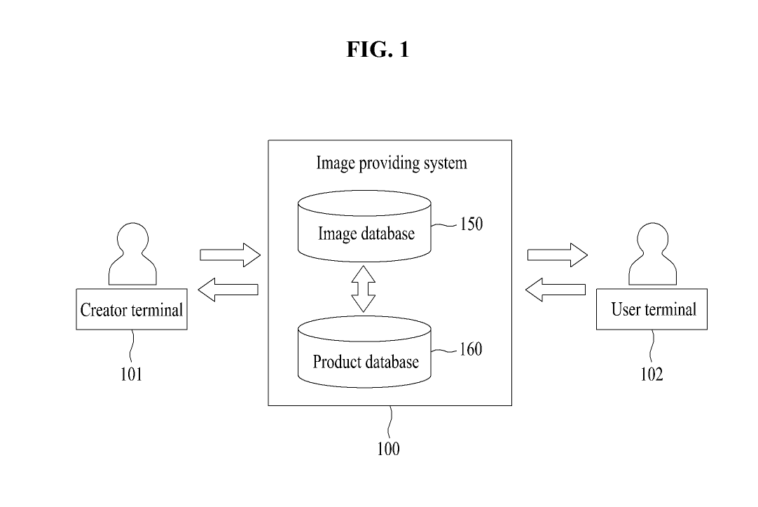

FIG. 1 is a diagram illustrating an example of an image based service environment according to an example embodiment of the present invention.

FIG. 1 illustrates a creator terminal 101, an image providing system 100, and a user terminal 102. Arrow indicators between the creator terminal 101 and the image providing system 100 and between the image providing system 100 and the user terminal 102 indicate that data may be transmitted and received over a wired/wireless network.

The creator terminal 101 and the user terminal 102, as a device such as a personal computer (PC), a smartphone, and a tablet, indicate any type of terminal devices capable of connecting to a website/mobile site associated with the image providing system 100 or installing and executing a service exclusive application associated with the image providing system 100. Here, the creator terminal 101 and the user terminal 102 perform the overall service operation such as a service screen configuration, data input, data transmission and reception, and data storage, under control of the website/mobile site or the exclusive application.

A creator is an entity that provides, to the image providing system 100, an image directly taken or maintained by the creator terminal 101, and a user is an entity that consumes an image provided from the image providing system 100 through the user terminal 102.

Here, providing of an image may include directly providing an image from the creator terminal 101 to the image providing system 100 and uploading an image from the creator terminal 101 to a backup system, for example, a cloud service system, included in the image providing system 100 or connected to the image providing system 100.

Consuming of an image may include reading an image through the website/mobile site associated with the image providing system 100 or the service exclusive application and any types of consuming practices that connect to creating actual revenues. For example, consuming of an image may indicate any type of consumptions such as reading of an image, a reaction, for example, a variety of interactions such as pick, like, share, and sympathy, to an image, clicking of an image, downloading of an image, a page view, a page navigate, and a product purchase.

The image providing system 100 functions as a service platform to provide an image based service. In particular, the image providing system 100 may provide a platform to relay an image associated with a travel product based on metadata of an image file. The image providing system 100 may be configured as an internal system being directly run by a provider having proposed the image based service disclosed herein or may be configured in a form of a system being run by a 3^{rd} party service provider.

Hereinafter, an operation of the image providing system 100 will be further described.

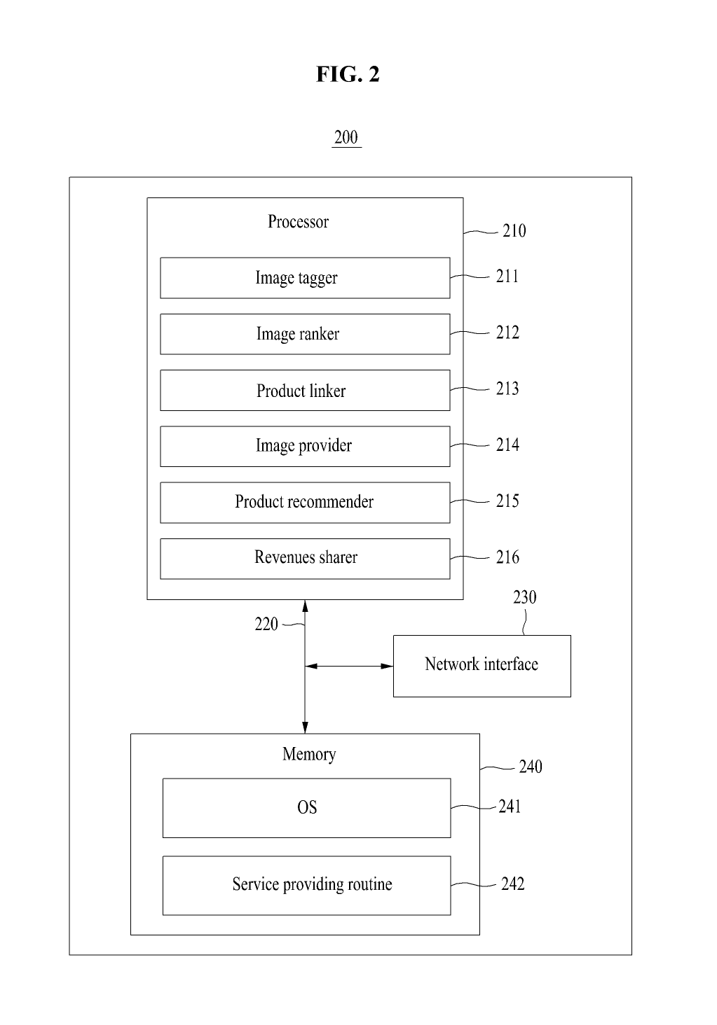

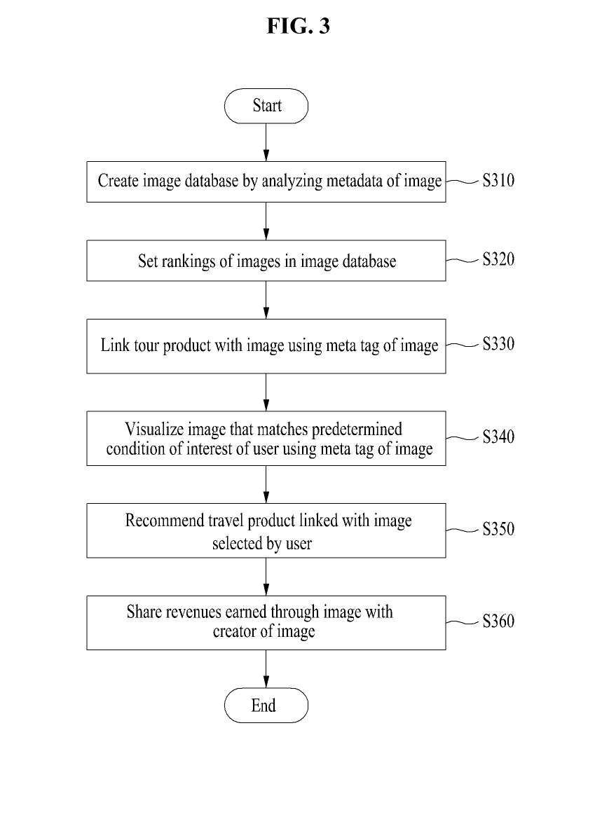

FIG. 2 is a block diagram illustrating a configuration of an image providing system according to one example embodiment, and FIG. 3 is a flowchart illustrating an image providing method according to an example embodiment.

Referring to FIG. 2, the image providing system 200 includes a processor 210, a bus 220, a network interface 230, and a memory 240. The memory 240 includes an operating system (OS) 241 and a service providing routine 242. The processor 210 includes an image tagger 211, an image ranker 212, a product linker 213, an image provider 214, a product recommender 215, and a revenues sharer 216, which are functional elements or operations executed by the processor. According to other example embodiments, the image providing system 200 may include a more number of constituent elements than the number of constituent elements of FIG. 2.

The memory 240, as non-transitory computer readable media, may include a permanent mass storage device such as random access memory (RAM), read only memory (ROM), and a disk drive. Also, a program code for the OS 241 and the service providing routine 242 may be stored in the memory 240. The software constituent elements may be loaded from non-transitory computer-readable media separate from the memory 240 using a drive mechanism (not shown). The non-transitory computer-readable media may include computer-readable media such as a floppy disk, a tape, a DVD/CD-ROM drive, and a memory card. According to other example embodiments, the software constituent elements may be loaded to the memory 240 through the network interface 230, instead of using the non-transitory computer readable media.

The bus 220 enables communication and data transmission between the constituent elements of the image providing system 200. The bus 220 may be configured using a high-speed serial bus, a parallel bus, a storage area network (SAN), and/or other appropriate communication technologies.

The network interface 230 may be a computer hardware constituent element to connect the image providing system 200 to a computer network. The network interface 230 connects the image providing system 200 to the computer network through a wireless or wired connection.

The processor 210 is configured to process an instruction of a computer program by performing a basic arithmetic and logic operation, and an input/output (I/O) operation of the image providing system 200. The instruction may be provided from the memory 240 or the network interface 230 to the processor 210 through the bus 220. The processor 210 is configured to execute a program code for the image tagger 211, the image ranker 212, the product linker 213, the image provider 214, the product recommender 215, and the revenues sharer 216. The program codes may be stored in a storage device such as the memory 240.

The image tagger 211, the image ranker 212, the product linker 213, the image provider 214, the product recommender 215, and the revenues sharer 216 may be configured to perform operations S310 through S360 of FIG. 3.

In operation S310, the image tagger 211 performs an automatic image tagging based on metadata of an image provided from a creator. For example, the image providing system 200 may connect a function of storing an image file, a function of displaying a travel route using the image file, a function of authenticating a travel of a user, and a function of providing a travel note draft so that the user may create a travel note to an image cloud service. Creators may upload image files created by the creators to an image cloud. Accordingly, the image tagger 211 may create an image database in which the uploaded images are classifiable based on metadata of the images by automatically analyzing the metadata of the uploaded images. In particular, the image tagger 211 may create the image database by applying metadata indicating space and time to each image by analyzing metadata of an image provided from a creator. Further, the image tagger 211 may include additional information such as the weather, in addition to space and time through metadata analysis of an image file. In this example, when region information associated with the space through metadata analysis of an image file is absent, the image tagger 211 may provide a region tagging alert and may provide a tagging service so that a creator may directly tag a region when registering an image. When region information associated with the space is absent in metadata of the image file, a ranking penalty may be applied to the corresponding image during a ranking setting process to be described below.

In operation S320, the image ranker 212 sets rankings of images in the image database. For example, the image ranker 212 may set an image ranking based on at least one of a type of a meta tag of an image, the latest and the performance of the image, and the performance of a creator that is an image provider. Here, the performance of the image may refer to the outcome according to an image consumption, and may be applied as a concept similar to the quality index of an individual advertisement unit in a general advertising field. The performance of the creator may refer to the outcome according to the image consumption, and may be applied as a concept similar to a quality index of a site unit in the general advertising field.

In operation S330, the product linker 213 links an advertising product or other types of content with an image using the meta tag of the image. For example, the product linker 213 may automatically link at least one image matched with attribute information of a travel product to the travel product stored in a product database, or may link an image designated by a product seller among matching images. That is, the product linker 213 may link the travel product with an image matched with attribute information that includes a travel location, a travel time, and a travel theme of the travel product. A service for linking a travel product with an image stored in the image database may be provided to an individual travel site.

In operation S340, the image provider 214 displays, that is, visualizes an image that matches a predetermined condition of interest of a user using the meta tag of the image. In this instance, the condition of interest may include the place or the location as a spatial concept or a time zone, a month, and a season as a temporal concept. Further, the condition of interest may also include weather associated with a place and a time requested by the user. The condition of interest of the user may be directly input or set by the user. Alternatively, the condition of interest may be identified based on an Internet log, consumption behaviors of the user such as reading of an image, the reaction, for example, pick, like, share, and sympathy, to an image, clicking of an image, downloading of an image, a page view, and a page navigate. For example, the image provider 214 may display an image corresponding to a place and a time, for example, a time zone, a month, and a season, requested by a user based on a meta tag of the image. Also, in addition to the requested place and time, the image provider 214 may display an image list by applying additional information such as the weather corresponding to the requested place and time.

In operation S350, the product recommender 215 recommends a travel product linked with an image selected by the user from among the visualized images or an image corresponding to a place extracted from a space meta tag of the selected image. In this example, when a plurality of travel products is linked with the selected image, the product recommender 215 may recommend the travel products in order of rankings set for the travel products. A travel product to be recommended may include a predetermined itinerary or product, and may also include a configuration and estimate of a new product. For example, the travel product to be recommended may include a package tour that covers all of product configuring units such as transportation, a route, and a hotel, and a product that individually recommends product configuring units so that a user may directly select a desired product configuring unit, such as a free travel. That is, types of travel products may include a package tour, a semi-free travel, an all-free travel product, an optional travel product, a day travel product, and a product of transportation such as a flight, and a hotel product.

In operation S360, the revenues sharer 216 shares revenues earned through a marketing channel using an image with a creator of the image. That is, when the user reads the image and switches to a travel product, the revenues sharer 216 may distribute at least a portion of the revenues to the image creator. Here, the revenues sharer 216 may calculate a contributory proportion of an image made until the switch to the travel product is performed based on a display or a click for each image linked to the travel product, and may distribute revenues corresponding to the contributory portion of the image to the creator. Hereinafter, a process of creating an image database will be described.

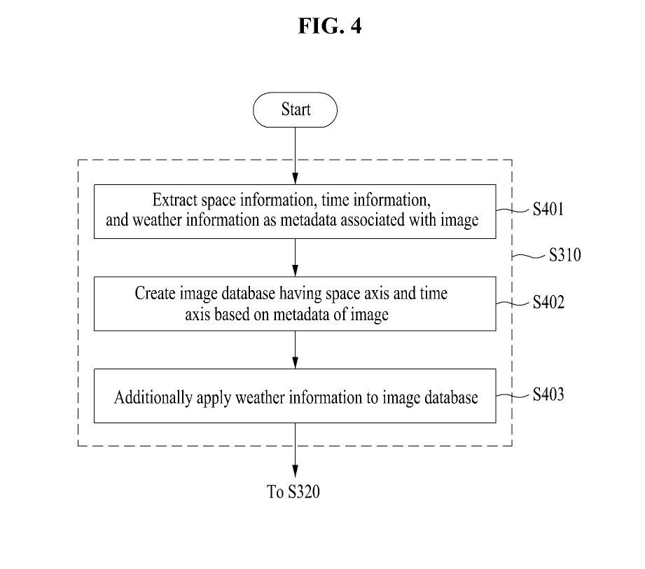

FIG. 4 is a flowchart illustrating a process of creating an image database by analyzing metadata of an image according to one example embodiment. Operations S401 through S403 of FIG. 4 are performed by the image tagger 211 of FIG. 2.

In operation S401, the image tagger 211 extracts space information, time information, and weather information as metadata associated with an image. For example, the image tagger 211 may automatically extract metadata from information tagged to the image, by considering that a recent camera function includes a function of automatically tagging the location, the time, and the weather associated with photographing. As another example, the image tagger 211 may automatically extract metadata through a contour detection and a shadowing analysis based on feature information included in an image file. As another example, the image tagger 211 may provide a query to a creator when the creator provides an image, and may extract metadata through a response of the creator to the query. Here, weather information may be extracted through an analysis of metadata and may also be acquired by verifying weather corresponding to space and time from Internet information, for example, weather center information. For example, the image tagger 211 may acquire weather information based on a space-time meta tag acquired from a GPS of a creator terminal using a weather information application program interface (API).

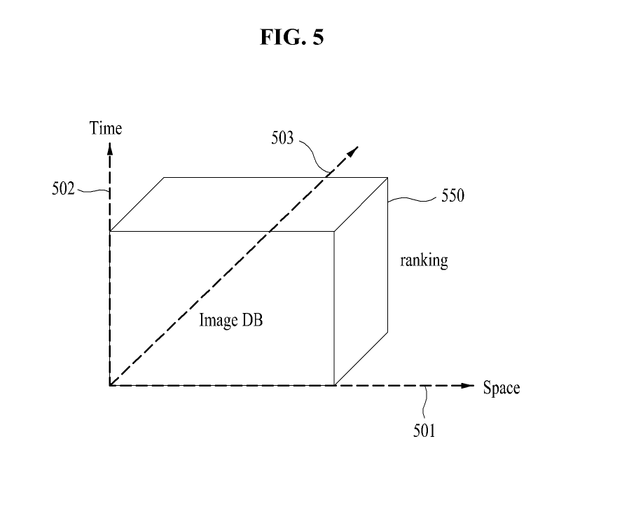

In operation S402, the image tagger 211 creates an image database in which images are classifiable based on the extracted metadata. Here, the image tagger 211 may create space information and time information of the image as a meta tag for search and may add the same to a corresponding image file. For example, referring to FIG. 5, the image tagger 211 may create an image database 550 having a space axis 501 and a time axis 502 to be capable of classifying a plurality of images provided from creators based on time information and space information.

In operation S403, the image tagger 211 additionally applies weather information extracted or acquired in operation S401 to the image database. That is, the image tagger 211 may create and add, as a meta tag for search, weather information together with space information and time information, in order to classify an image corresponding to predetermined weather, for example, a rainy day, among images matching a predetermined space and/or time.

Thus, according to example embodiments, it is possible to construct a matching database in which an image is classifiable for each space, each time, and each weather by extracting space information, time information, and weather information through metadata analysis of an image provided by a creator.

Hereinafter, a process of setting an image ranking will be described. The image ranker 212 sets a ranking based on at least one of a meta tag type of an image, the latest and the performance of an image, and the performance of a creator that is an image provider with respect to the image database. For example, the image ranker 212 may assign points based on the meta tag type of the image. Here, the image ranker 212 may assign a weight to each meta tag or may assign different weights based on the meta tag type. For example, the image ranker 212 may assign a relatively high weight in order of space, time, and weather. Accordingly, the image ranker 212 may assign relatively high points to an image tagged with at least two meta tags compared to an image tagged with a single meta tag, or may assign relatively high points to an image tagged with a space meta tag compared to an image tagged with a time or weather meta tag. As another example, the image ranker 212 may apply an advantage regulation through a penalty regulation based on whether a predetermined meta tag is tagged. For example, the image ranker 212 may additionally assign predetermined points to an image tagged with a space meta tag and may subtract predetermined points from an image untagged with the space meta tag. As another example, the image ranker 212 may set rankings of the entire images stored in the image database based on the storage order from the latest or the most recent to the oldest. Here, the image ranker 212 may set display rankings to be moved back by sorting the entire matching images for each place or time based on the storage order from the latest to the earliest and then applying a penalty to images of top n% or less. As another example, the image ranker 212 may set a ranking by measuring and indexing the outcome according to an image consumption of an individual image such as reading of the image, a reaction to the image, clicking of the image, downloading of the image, a page view, a page navigate, and a product purchase, based on a predetermined reference display level. As another example, the image ranker 212 may set a ranking of an image based on an index for each creator by calculating points based on all the images registered by each creator as a performance of a creator. For example, the image ranker 212 may index the number of images registered by a creator, how often the creator registers an image, and how often images registered by the creator have been selected as top n%.

The image ranker 212 may additionally apply ranking information of the image to the image database. That is, referring to FIG. 5, the image ranker 212 may construct the image database 550 including a ranking axis 503 to be capable of identifying rankings of all of the images stored in the image database 550 or images matching the same space or time.

Thus, according to example embodiments, it is possible to set rankings of images in the image database that are to be used as a display criterion. Through this, an image tagged with a primary meta tag, the latest image, an image gaining great reaction from users, and an image registered by a creator having previously registered a large number of excellent images may be processed to be preferentially displayed.

Hereinafter, a matching process between a travel product and an image will be described. The product linker 213 may match a travel product corresponding to an image with the image in association with the travel product and the image. For example, when a travel product corresponding to a predetermined location is initially registered by a product seller and an image having an attribute of the same location as the location of the travel product is provided, the product linker 213 may automatically link the travel product with the image. As another example, when a travel product corresponding to a predetermined location is registered by a product seller, the product linker 213 may automatically link all of images having an attribute of the same location as the location of the travel product among all of the previously provided images. As another example, when a travel product corresponding to a predetermined location is registered by a product seller, the product linker 213 may display all of images having an attribute of the same location as the location of the travel product for the product seller and then link an image selected by the product seller from among the images to the travel product. The travel product may include a single place of destination. In general, the travel product may include a plurality of destinations and thus, images having different location tags may be linked to a single travel product so that the images may correspond to all of the destinations included in the travel product. That is, the product linker 213 may link different places of images based on a destination included in a travel product, for each travel product. For example, when a user is verified to be interested in Montmartre, Champs Elysees, and Louvers of Paris, a travel product including the three destinations, a travel product including at least one of the three destinations, a product of which an estimate is calculable by including the three destinations, and a product associated with transportation or a hotel around at least one of the three destinations may be provided as recommended travel products based on rankings

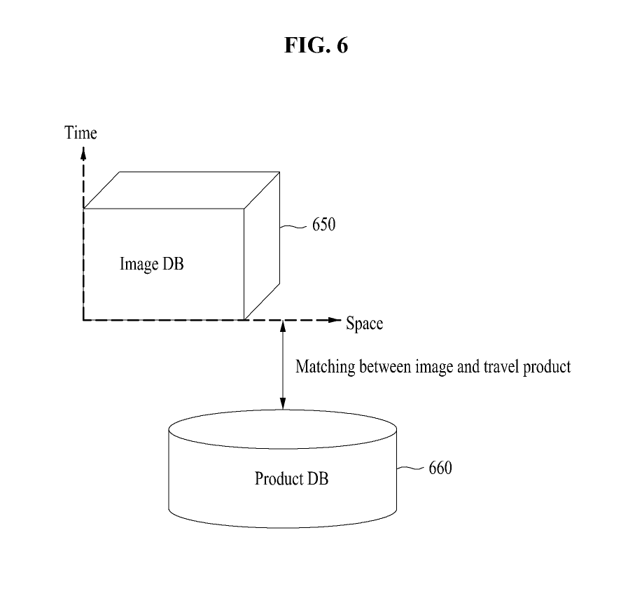

Referring to FIG. 6, according to an example embodiment, a platform configured to perform matching between an image and a travel product by linking an image of an image database 650 having a space axis and a time axis to a travel product of a product database 660 may be constructed.

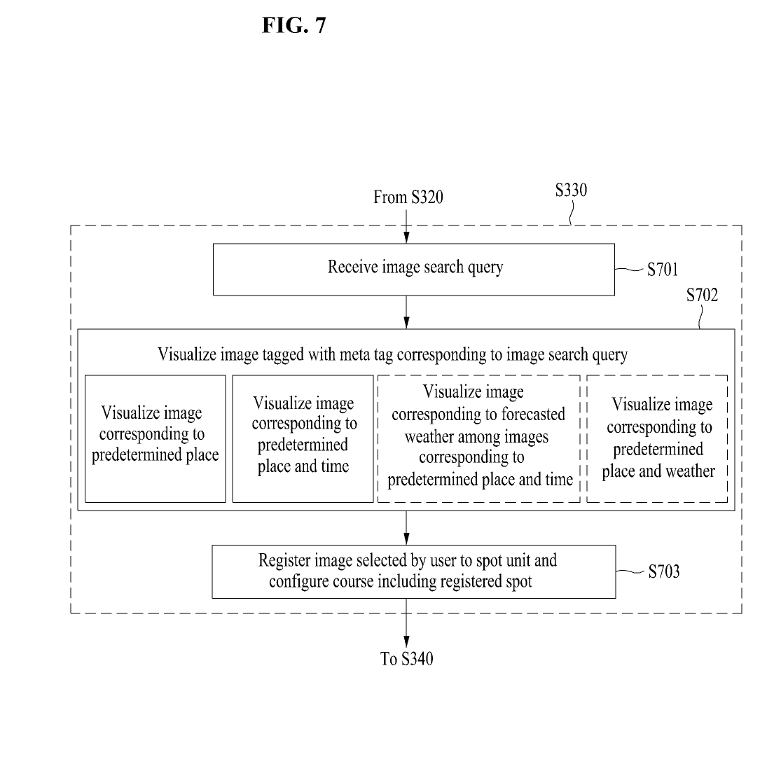

FIG. 7 is a flowchart illustrating a process of visualizing an image according to one example embodiment. Operations S701 through 5703 of FIG. 7 may be performed by the image provider 214 of FIG. 2.

In operation S701, the image provider 214 receives an image search query corresponding to a condition of interest of a user. For example, the image search query may be input using a method of directly inputting a condition of interest, such as a keyword input method and a search condition selecting method using a select box. As another example, a condition of interest may be directly set by a user. Alternatively, a condition of interest of a user may be automatically set based on an Internet log or a previous image consumption behavior and, when the user approaches a service, an image search query may be automatically created and input based on the set condition of interest. Here, the image search query may include at least one query among space, for example, a place or a location; time, for example, a time zone, a month, and a season; and weather, for example, a sunny day, a cloudy day, a rainy day, and a snowy day.

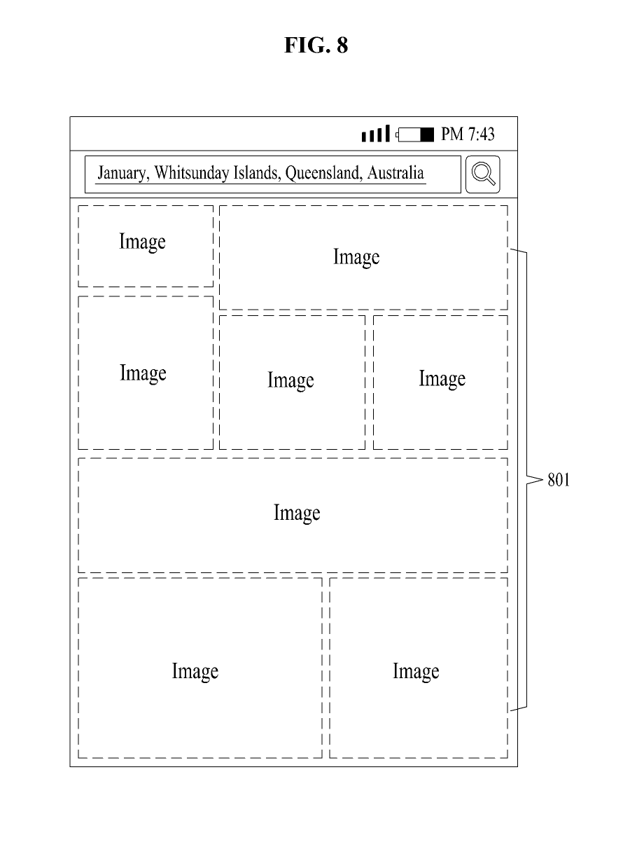

In operation S702, the image provider 214 displays, that is, visualizes an image tagged with a meta tag corresponding to the image search query among images stored in an image database. For example, when only a place query is included in the image search query, such as searching for an image of “Whitsunday Islands, Queensland, Australia”, an image tagged with a place corresponding to the image search query may be visualized. As another example, when a place query and a time query are included in the image search query, an image tagged with a place and time corresponding to the image search query may be visualized. For example, referring to FIG. 8, the image provider 214 may extract and visualize images 801 tagged with time and a place as “January” and “Whitsunday Islands, Queensland, Australia” with respect to a keyword of “January Whitsunday Islands, Queensland, Australia”. Here, as another visualization example, the image provider 214 may verify weather forecasted based on the place and the time corresponding to the image search query in association with weather forecast and then visualize an image tagged with a meta tag corresponding to the weather. For example, when weather of “Whitsunday Islands, Queensland, Australia” on “January 1” is forecasted to be “sunny” in response to a search for an image of “Whitsunday Islands, Queensland, Australia” on “January 1”, the image provider 214 may select and visualize an image tagged with a weather tag “sunny day” among images tagged with a place as “Whitsunday Islands, Queensland, Australia” and the time as “January” or “January 1”. As another example, when a place query and a weather query are included in the image search query, such as searching for an image with “sunny day” among images of “Whitsunday Islands, Queensland, Australia”, the image provider 214 may visualize an image tagged with a place and weather corresponding to the image search query. Here, when a plurality of images corresponds to the image search query, the image provider 214 may display the images based on rankings set for the images. Rankings of images may be determined based on popularity according to the number of displays for each image and a user feedback, for example, clicks and recommendations.

In operation S703, the image provider 214 may register an image selected by the user from among images visualized using an image meta tag based on a geographical spot or a location. Further, the image provider 214 may automatically configure a course of travel including a plurality of registered spots. For example, when the user selects an image including some places while consuming a plurality of places of images, the image provider 214 may automatically configure a guidebook, for example, a travel route that connects the places of the selected image. Here, a travel course including spots registered by the user may be used during a process of recommending a travel product to the user.

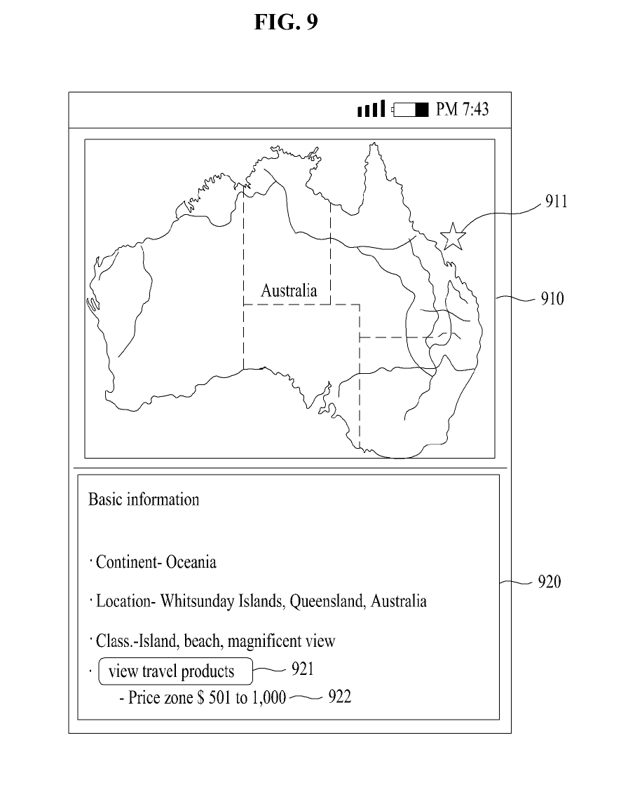

Here, when the user selects an image from among visualized images, the image provider 214 may provide basic information associated with the selected image. For example, when the user selects an image from among the visualized images 801 of FIG. 8, the image provider 214 may provide a map 910 and basic information 920 associated with the selected image as illustrated in FIG. 9. A location 911 of a place tagged to the image may be displayed on the map 910. The basic information 920 may include a link 921 associated with a travel product and a price zone 922 of the travel product.

According to example embodiments, it is possible to visualize images corresponding to a place requested by a user and to visualize images by further additionally applying at least one concept of time and weather.

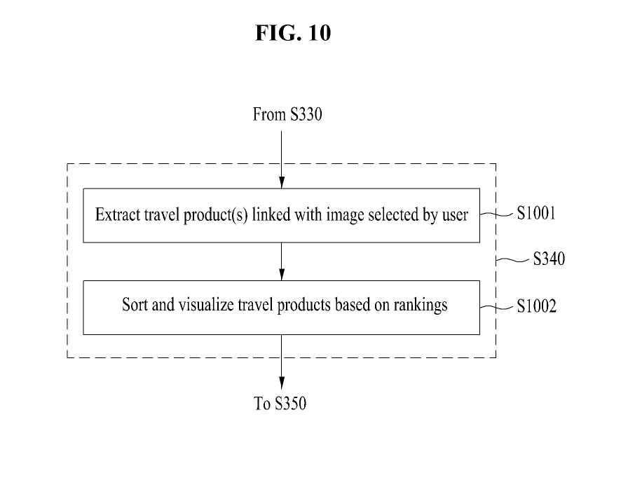

FIG. 10 is a flowchart illustrating a process of recommending a travel product according to an example embodiment. Operations S1001 and S1002 of FIG. 10 may be performed by the product recommender 215 of FIG. 2.

In operation S1001, the product recommender 215 extracts a travel product linked with an image selected by a user, to perform a travel product recommendation. For example, with respect to an image selected by the user from among visualized images, the product recommender 215 may extract a travel product linked with the corresponding image. As another example, the product recommender 215 may extract a travel product linked with an image corresponding to a spot registered by the user or may extract a travel product with a course including a plurality of spots registered by the user. As another example, a region of interest (ROI) of the user may be identified and stored based on images associated with a consumption behavior of the user among previously visualized images. Accordingly, the product recommender 215 may create a travel guidebook in which travel candidate places corresponding to the ROI of the user are collected and then may extract a travel product associated with the ROI of the user based on the travel guidebook.

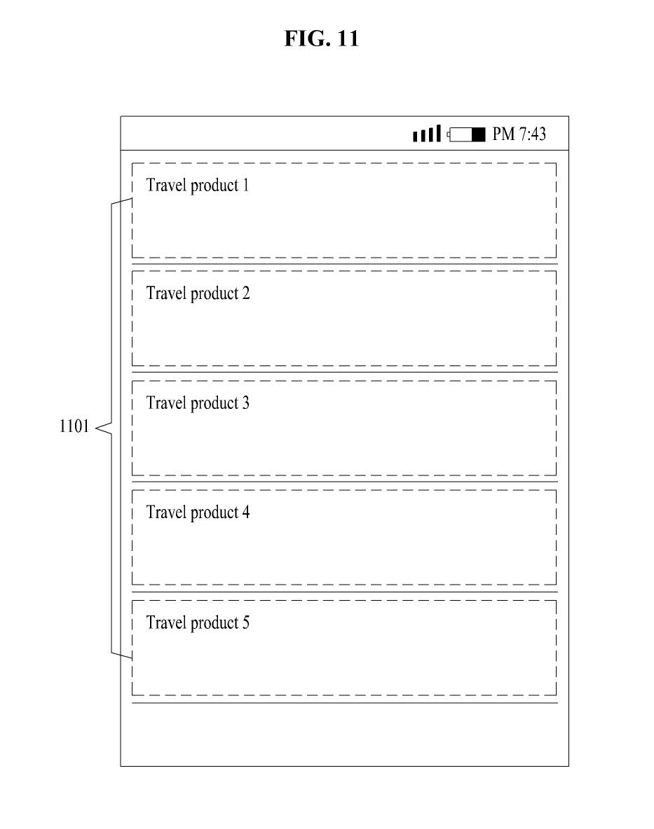

In operation S1002, the product recommender 215 visualizes the extracted travel product for the user. For example, when the user selects an image from among the visualized images 801 of FIG. 8 or selects the link 921 of FIG. 9 associated with the travel product, the product recommender 215 visualizes a list 1101 of travel products linked with the selected image as illustrated in FIG. 11. In particular, when a plurality of travel products is extracted in operation S1001, the product recommender 215 sorts and visualizes the travel products based on rankings set for the travel products. Here, the rankings of the travel products may be determined based on a correlation level with the image, popularity according to a user feedback, and a bid price. For example, the correlation level with the image indicates the number of pieces of information matched between a travel product and an image. For example, compared to a travel product matched with an image in terms of only a spatial concept, a travel product matched with the image in terms of all of the spatial concept and a temporal concept may be set to have a relatively high ranking

According to example embodiments, it is possible to recommend a travel product linked with an image through matching between the image and the travel product.

Further, according to example embodiments, it is possible to distribute a portion of revenues earned through switching of a user with respect to an image to an image creator based on a contributory proportion of the image. In this example, the user may register an image or a travel note based on a course unit including a plurality of registered spots, instead of a single unit through an image read. Here, when revenues are earned, the earned revenues may be distributed to all of the image creators constituting the course unit.

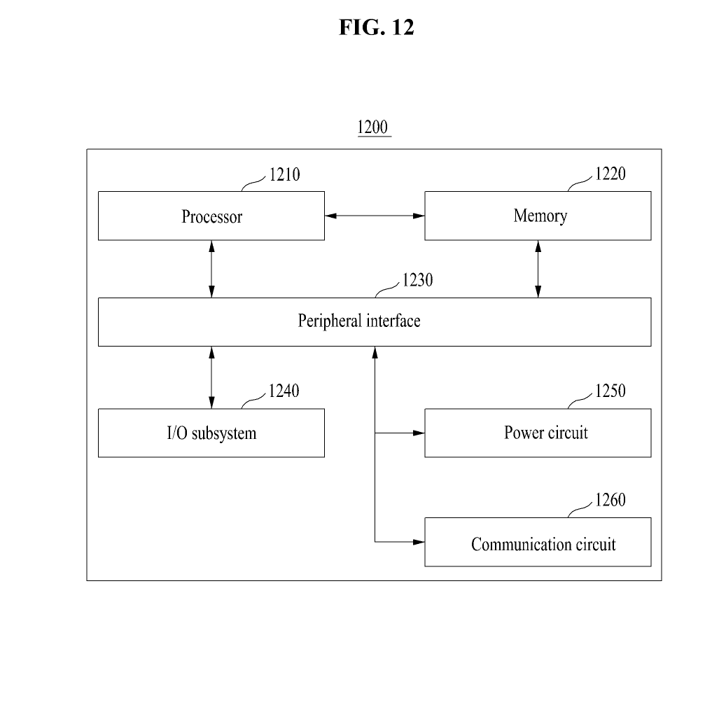

FIG. 12 is a block diagram illustrating a configuration of a computer system 1200 according to one example embodiment. Referring to FIG. 12, the computer system 1200 includes at least one processor 1210, a memory 1220, a peripheral interface 1230, an input/output (I/O) subsystem 1240, a power circuit 1250, and a communication circuit 1260. Here, the computer system 1200 may correspond to a creator terminal/user device.

The memory 1220 may include, for example, a high-speed random access memory (HSRAM), a magnetic disk, a static random access memory (SRAM), a dynamic RAM (DRAM), read only memory (ROM), a flash memory, and a non-volatile memory. The memory 1220 may include a software module, an instruction set, or a variety of data required for an operation of the computer system 1200. Here, an access from another component such as the processor 1210 and the peripheral interface 1230 to the memory 1220 may be controlled by the processor 1210.

The peripheral interface 1230 couples an input device and/or output device of the computer system 1200 with the processor 1210 and the memory 1220. The processor 1210 performs a variety of functions for the computer system 1200 and process data by executing the software module or the instruction set stored in the memory 1220.

The I/O subsystem 1240 may couple various I/O peripheral devices with the peripheral interface 1230. For example, the I/O subsystem 1240 may include a controller for coupling the peripheral interface 1230 and a peripheral device such as a monitor, a keyboard, a mouse, a printer, and a touch screen or a sensor depending on necessity. The I/O peripheral devices may be coupled with the peripheral interface 1230 without using the I/O subsystem 1240.

The power circuit 1250 supplies power to all of or a portion of components of a terminal. For example, the power circuit 1250 may include a power management system, at least one power source such as a battery and alternating circuit (AC), a charge system, a power failure detection circuit, a power converter or inverter, a power status indicator, or other components for creating, managing and distributing power.

The communication circuit 1260 enables communication with another computer system using at least one external port. Alternatively, as described above, the communication circuit 1260 may enable communication with another computer system by including a radio frequency (RF) circuit and thereby transmitting and receiving an RF signal known as an electromagnetic signal.

FIG. 12 illustrates only one example of a computer system 1200. The computer system 1200 may have a configuration or an arrangement for omitting a portion of the components illustrated in FIG. 12, further including components not illustrated in FIG. 12, or coupling two or more components. For example, a computer system for a communication terminal of a mobile environment may further include a touch screen, a sensor, and the like, in addition to the components of FIG. 12. A circuit for RF communication using a variety of communication methods, for example, wireless fidelity (Wi-Fi), 3^{rd} generation (3G), long term evolution (LTE), Bluetooth, near field communication (NFC), and ZigBee, may be included in the communication circuit 1260. Components includable in the computer system 1200 may be configured as hardware that includes an integrated circuit specified for at least one signal processing or application, software, or a combination of hardware and software.

Description is made above with reference to screens (see FIG. 2 and FIGS. 5 through 11) executed on a mobile terminal. However, it is only an example and the example embodiments are not limited thereto and may be implemented in a website environment of a general PC.

According to example embodiments, it is possible to create a matching database in which an image is classifiable based on at least one of space, time, and weather by analyzing metadata of the image. Accordingly, it is possible to provide an expanded service by efficiently using significant data of a source image. Also, according to example embodiments, it is possible to conduct an image search based on an ROI of a user. Further, it is possible to search for an image of a predetermined location based on season, time, and weather. Also, according to example embodiments, it is possible to effectively recommend a travel product associated with an image through matching between the travel product and the image by linking the travel product with the image based on metadata of the image. Also, according to example embodiments, it is possible to achieve revenues by using an image as a marketing channel. Here, it is possible to further efficiently advertise a product by sharing the revenues with an image creator.

The components or units, i.e., the processor 210, the memory 240 and the network interface 230, described above with respect to FIG. 2 may be implemented using hardware components, software components, or a combination thereof. For example, the processor 210 may be implemented using one or more general-purpose or special purpose computers, such as, for example, a controller and an arithmetic logic unit, a digital signal processor, a microcomputer, a field programmable array, a programmable logic unit, a microprocessor or any other device capable of responding to and executing instructions in a defined manner. The processor 210 may run an operating system (OS) and one or more software applications that run on the OS. The processor 210 also may access, store, manipulate, process, and create data in response to execution of the software. For purpose of simplicity, the description of the processor 210 is used as singular; however, one skilled in the art will appreciated that the processor 210 may include multiple processing elements and multiple types of processing elements. For example, the processor 210 may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory

(ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments.

It will be apparent to those skilled in the art that various modifications and variation can be made in the example embodiments without departing from the spirit or scope of the invention. Thus, it is intended that the example embodiments cover the modifications and variations of this invention provided they come within the scope of the appended claims and their equivalents.

What is claimed is:

1. An image providing method configured as a computer, the method comprising:
matching a meta tag for search with an image by analyzing metadata of the image in response to a first user uploading the image; and
classifying and displaying the image based on the meta tag in response to an image read request of a second user.

2. The method of claim 1, wherein the matching comprises acquiring at least one of space information, time information, and weather information about the image, and matching the meta tag indicating the acquired information with the image.

3. The method of claim 1, wherein the classifying and the displaying comprises displaying an image matching a meta tag corresponding to a search query of the second user.

4. The method of claim 2, wherein the classifying and the displaying comprises displaying an image matching a meta tag corresponding to at least one of a place, a time, and weather selected by the second user.

5. The method of claim 2, wherein the classifying and the displaying comprises displaying an image matching a meta tag corresponding to weather forecasted on a place and a time selected by the second user, among images matching a meta tag corresponding to the selected location and time.

6. The method of claim 1, further comprising:
setting a ranking of the image based on at least one of a meta tag of the image, a latest of the image, a performance associated with a reaction to displaying of the image, and a performance according to an image related history of the first user.

7. The method of claim 1, further comprising:
linking at least one travel product with the image using the meta tag; and
displaying a travel product linked with a predetermined image in response to the image selected by the second user from among the displayed images.

8. The method of claim 7, wherein the matching comprises acquiring space information about the image and matching a meta tag indicating the space information with the image, and
the linking comprises linking the travel product with an image matching a meta tag corresponding to a place attribute of the travel product.

9. The method of claim 1, further comprising:
sharing revenues earned through a marketing channel using the image with the first user having uploaded the image.

10. The method of claim 7, further comprising:
sharing revenues earned from the travel product with the first user having uploaded the image linked to the travel product.

11. The method of claim 10, wherein the sharing comprises calculating a contributory portion based on displaying and selecting of each image in response to the travel product being linked with a plurality of images, and distributing the revenues based on the contributory portion for each image.

12. An image providing system comprising:
an image tagger configured to match a meta tag for search with an image by analyzing metadata of the image in response to a first user uploading the image; and
an image provider configured to classify and display the image based on the meta tag in response to an image read request of a second user.

13. The image providing system of claim 12, wherein the image tagger is configured to acquire at least one of space information, time information, and weather information about the image, and to match the meta tag indicating the acquired information with the image.

14. The image providing system of claim 12, wherein the image provider is configured to display an image matching a meta tag corresponding to a search query of the second user.

15. The image providing system of claim 13, wherein the image provider is configured to display an image matching a meta tag corresponding to at least one of a place, a time, and weather selected by the second user.

16. The image providing system of claim 12, further comprising:
a product linker configured to link at least one travel product with the image using the meta tag; and
a product recommender configured to display a travel product linked with a predetermined image in response to the image selected by the second user from among the displayed images.

17. The image providing system of claim 16, wherein the image tagger is configured to acquire space information about the image and to match a meta tag indicating the space information with the image, and
the product linker is configured to link the travel product with an image matching a meta tag corresponding to a place attribute of the travel product.

18. The image providing system of claim 16, further comprising:
a revenues sharer configured to share revenues earned from the travel product with the first user having uploaded the image linked to the travel product.

19. The image providing system of claim 18, wherein the revenues sharer is configured to calculate a contributory portion based on displaying and selecting of each image in response to the travel product being linked with a plurality of images, and to distribute the revenues based on the contributory portion for each image.

20. A non-transitory computer-readable medium storing an instruction to control a computer system to provide a map service, wherein the instruction is configured to control the computer system by a method comprising:
matching a meta tag for search with an image by analyzing metadata of the image in response to a first user uploading the image;
linking at least one travel product with the image using the meta tag;
classifying and displaying the image based on the meta tag in response to an image read request of a second user; and
displaying a travel product linked with a predetermined image in response to the image selected by the second user from among the displayed images.
